(19) United States
(12) Patent Application Publication
(10) Pub. No.: US 2022/0392186 A1
(43) Pub. Date: Dec. 8, 2022

(54) REGION OF INTEREST EXTRACTION FROM REFERENCE IMAGE USING OBJECT MAP

(71) Applicant: Hewleit-Packard Develapmeni Company, L.P., Spring, TX (US)

(72) Inventors: Richard E. Maggard, Boise, ID (US); Yousun Bang, SeengnamSi (KR); Minki Cho, Pangyo (KR); Mark Shaw, Boise, ID (US); Jan Allebach, Boise, ID (US); Runzhe Zhang, Boise, ID (US)

(21) Appl. No.: 17/776,781

(22) PCT Filed: Jan. 23, 2020
(86) PCT No.: PCT/US2020/014849

§ 371 Date: May 13, 2022

(51) Int. Cl. G06V 10/25; G06T 7/11; G06V 10/98; G06V 10/75

(52) U.S. Cl. CPC G06V 10/25; G06T 7/11; G06V 10/993; G06V 10/751

(57) ABSTRACT

For each of a number of regions of interest (ROI) types, ROIs are extracted from a reference image based on an object map distinguishing symbol, raster, and vector objects within the reference image. Whether print quality of a printing device has degraded below a specified acceptable print quality level is assessed based on a comparison of the extracted ROIs within the reference image to corresponding ROIs within a test image corresponding to the reference image and printed by the printing device.

### BACKGROUND

Printing devices can use a variety of different technologies to form images on media such as paper. Such technologies include dry electrophotography (EP) and liquid EP (LEP) technologies, which may be considered as different types of laser and light-emitting diode (LED) printing technologies, as well as fluid-jet printing technologies like inkjet-printing technologies, Printing devices deposit print material, such as colorant like dry and liquid toner as well as printing fluids like ink, among other types of print material.

### BRIEF DESCRIPTION OF THE DRAWINGS

FIG. 1 is a flowchart of an example method for assessing and correcting print quality degradation based on a comparison of regions of interest (ROIs) extracted from a reference image and corresponding ROIs extracted from a corresponding test image.

FIGS, 2A, 2B, and 2C are diagrams of an example reference image, an example object map of the reference image, and example ROIs extracted from the example reference image based on the example object map, respectively.

FIG. 3 is a flowchart of an example method for extracting raster ROIs from a reference image.

FIGS. 4A, 4B, 4C, 4D, 4E, and 4F are diagrams illustratively depicting example performance of portions of the method of FIG. 3.

FIG. 5 is a flowchart of an example method for extracting symbol ROIs from a reference image.

FIGS. 6A, 6B, 6C, 6D, and 6E are diagrams illustratively depicting example performance of portions of the method of FIG. 5.

FIG. 7 is a flowchart of an example method for extracting background ROIs from a reference image.

FIGS. 8A, 8B, and 8C are diagrams illustratively depicting example performance of portions of the method of FIG. 7.

FIG. 9 is a flowchart of an example method for extracting a deepest background ROI from a reference image using a chessboard technique.

FIGS. 10A and 10B are diagrams illustratively depicting example performance of portions of the method of FIG. 9.

FIGS. 11A, 11B, and 11C are flowcharts of an example method for extracting a maximum background ROI using an accumulation matrix technique,

FIGS. 12A, 12B, and 12C are diagrams illustratively depicting example performance of portions of the method of FIGS. 11A, 11B, and 11C.

FIGS. 13A and 13B are diagrams illustratively depicting example performance of other portions of the method of FIG. 7.

FIG. 14 is a flowchart of an example method.

FIG. 15 is a diagram of an example printing device.

FIG. 16 is diagram of an example computer-readable data storage medium.

### DETAILED DESCRIPTION

As noted in the background, printing devices can be used to form images on media using a variety of different technologies. While printing technologies have evolved over time, they are still susceptible to various print defects. Such defects may at first manifest themselves nearly imperceptibly before reaching the point at which print quality has inescapably degraded. Detecting print quality degradation before it becomes too excessive can make ameliorating the root problem less costly and time-consuming, and can also improve end user satisfaction of a printing device. Accurate identification and assessment of print quality degradation can assist in the identification of the defects responsible for and the root causes of the degradation,

Assessing degradation in the print quality of a printing device has traditionally been a cumbersome, time-consuming, and costly affair. An end user prints a specially designed test image and provides the printed image to an expert. The expert in turn evaluates the test image, looking for telltale signs of print defects to assess the overall degradation in print quality of the printing device. Upon locating such print defects, the expert may be able to discern the root causes of the degradation and provide solutions to resolve them. With the provided solutions in hand, the end user may thus be able to fix the problems before they become too unwieldy to correct or more severely impact print quality.

Techniques described herein, by comparison, provide for a way by which degradation in the print quality of a printing device can be assessed without having to involve an expert or other user. The techniques instead extract regions of interest (ROIs) within a reference image corresponding to a test image that a printing device has printed. Corresponding ROIs extracted from the test image characterize image quality defects within the test image. The ROIs are of different ROI types, including raster, symbol, background, and vector ROI types, for instance. Whether print quality has degraded below a specified level of acceptability can be assessed based on a comparison of the ROIs within the reference image and the corresponding ROIs within the test image,

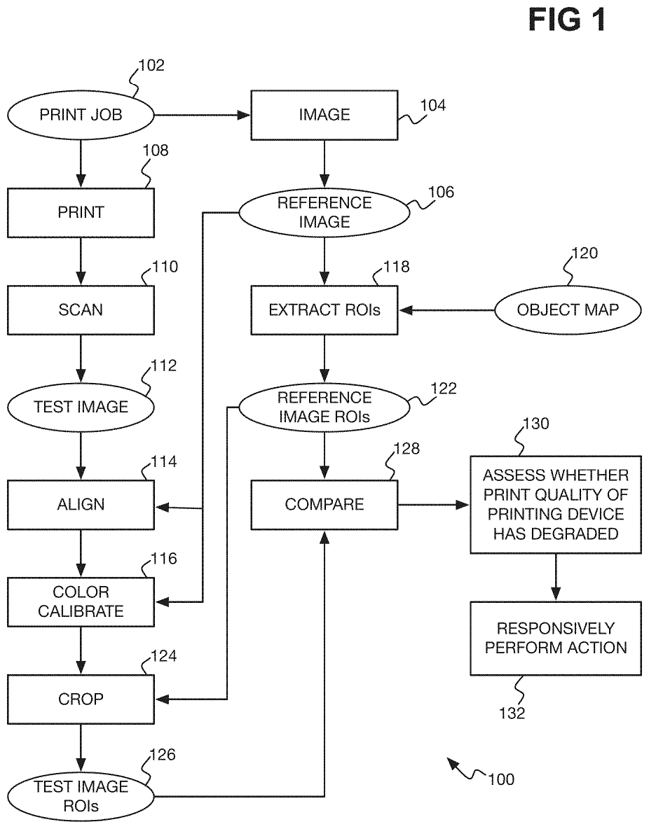

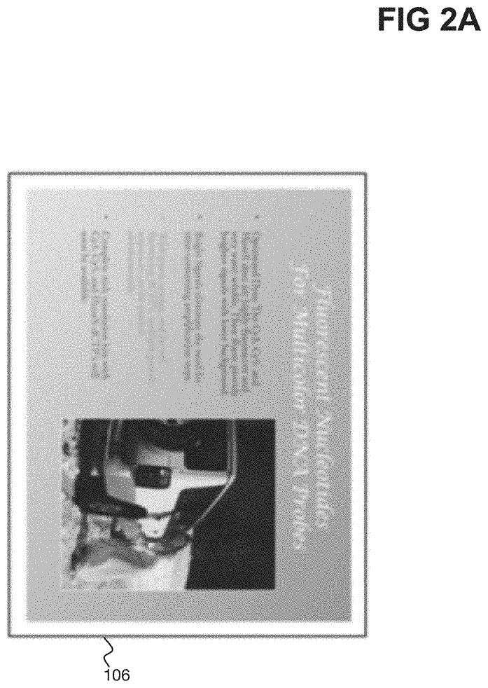

FIG. 1 shows an example method 100 for assessing and correcting print quality degradation based on a comparison of ROIs within a reference image and corresponding Rids within a corresponding test image. The method 100 may be implemented as program code stored on a non-transitory computer-readable data storage medium and executable by a processor. The processor may be part of a printing device like a printer, or a computing device such as a computer.

A print job 102 may include rendered data specially adapted to reveal image quality defects of a printing device when printed, or may be data submitted for printing during the normal course of usage of the device, such as by the end user, and then rendered. The print job 102 may be defined in a page description language (PDL), such as PostScript or the printer control language (PCL). The definition of the print job 102 can include text (e.g., human-readable) or binary data streams, intermixed with text or graphics to be printed. Source data may thus be rendered to generate the print job 102.

The method 100 includes imaging the print job 102 (104) to generate a reference image 106 of the job 102, Imaging the print job 102 means that the job 102 is converted to a pixel-based, or bitmap, reference image 106 having a number of pixels. The imaging process may be referred to as rasterization. The print job 102 is also printed (108) and scanned (110) to generate a test image 112 corresponding to the reference image 106. The print job 102 may be printed by a printing device performing the method 100, or by a computing device performing the method 100 sending the job 102 to a printing device. The print job 102 may be scanned using an optical scanner that may be part of the printing device or a standalone scanning device,

The method 100 includes extracting ROIs from the reference image 106 using an object map 120 for the reference image 106 (116), to generate reference image ROIs 122. The object map 120 distinguishes different types of objects within the reference image 106, and specifies the type of object to which each pixel of the image 106 belongs. Such different types of objects can include symbol objects including text and other symbols, raster images including pixel-based graphics, and vector objects including vector-based graphics, The object map 120 may be generated from the print job 102 or from the reference image 106. An example technique for generating the object map 120 from the reference image 106 is described in Z. Xiao et al., “Digital Image Segmentation for Object-Oriented Halftoning,” Color Imaging: Displaying, Processing, Hardcopy, and Applications 2016.

Extraction of the reference image ROIs 122 is described in detail later in the detailed description. Each reference image ROI 122 is a cropped portion of the reference image 106 of a particular ROI type. There may be multiple ROIs 122 of the same ROI type. The ROIs 122 are non-overlapping, and can identify areas of the reference image 106 in which print defects are most likely to occur and/or be discerned when the image 106 is printed,

The ROI types may correspond to the different object types of the object map 120 and include symbol and raster ROI types respectively corresponding to the symbol and raster object types. In one implementation, the ROI types may also include a vector ROI type corresponding to the vector object type. In another implementation, however, there may be two ROI types corresponding to the vector object type instead of just one. The vector ROI type may itself include just uniform non-white and smooth gradient color areas, whereas another, background ROI type may include uniform in which no colorant is printed, and which thus have the color of the media.

The method 100 can include aligning the printed and scanned test image 112 with the reference image 106 (114), to correct misalignment between the test image 112 and the reference image 106. That is, upon printing and scanning, the location of each pixel within the test image 112 may differ from the location of the corresponding pixel within the reference image 106. The alignment process can include shifting the test image 112 horizontally and/or vertically, among other operations, to align the locations of the pixels in the test image 112 with their corresponding pixels in the reference image 106, within a margin of error. An example alignment technique is described in A. Myronenko et al., “Intensity-Based Image Registration by Minimizing Residual Complexity,” 2010 IEEE transactions on medical imaging, 29(11).

The method 100 can include color calibrating the aligned test image 112 against the reference image 106 (116), to correct for color variations between the test image 112 and the reference image 106. That is, upon printing and scanning, the color of each pixel within the test image 112 may vary from the color of its corresponding pixel within the reference image 106, due to manufacturing and operational tolerances and characteristics of the printing device and/or the scanner. The color calibration process can thus modify the color of each pixel of the test image 112 so that it corresponds to the color of the corresponding pixel of the reference image 106, within a margin of error. An example color calibration technique is described in E. Reinhard et al., “Color Transfer Between Images,” 2001 IEEE Computer Graphics and Applications, 21(5).

The method 100 can include cropping the color calibrated test image 112 to generate test image ROIs 126 corresponding to the reference image ROIs 122 (124), For example, a reference image ROI 122 is a cropped portion of the reference image 106 at a particular location within the image 106 and having a particular size. As such, the corresponding test image ROI 126 is a cropped portion of the test image 112 at the same location within the image 112 and having the same particular size. There is therefore a one-to-one correspondence between the reference image ROIs 122 and the test image ROIs 126.

The method 100 can include comparing the reference image ROIs 122 to their corresponding test image ROIs 126 (128). For instance, each extracted reference image ROI 122 of each ROI type may be compared to its corresponding test image ROI 126 of the same ROI type. In one implementation, part 128 can be performed by the printing device that printed and scanned the print job 102 to generate the test image 112. In another implementation, part 128 can be performed by a computing device separate from the printing device. For example, once the printing device has printed the print job 102, a scanner that is part of the printing device or part of a standalone scanning device may scan the printed print job 102 to generate the test image 112, and then the computing device may perform part 128.

The method 100 can include assessing whether print quality of the printing device that printed the test image 112 has degraded below a specified acceptable print quality level (130), based on the comparison of the reference image ROIs 122 and the test image ROIs 126. In one implementation, the assessment is made based on feature vectors that are generated based on this comparison. A feature vector is a vector (e.g., collection or set) of image characteristic-based values. A feature vector can be defined for each ROI type to include such image characteristic-based values that best characterize the image quality defects within the test image 112 for that ROI type. An example technique for generating feature vectors is described in the co-filed PCT patent application entitled “Generation of Feature Vectors for Assessing Print Quality Degradation,” filed on [date], and assigned patent app. no. [number].

Print quality degradation assessment can be performed in a variety of different ways. For example, an unsupervised or supervised machine learning technique may be employed to discern whether print quality has degraded below a specified acceptable print quality level. As another example, a rule-based or other algorithm may be employed to assess whether print quality has degraded below a specified acceptable print quality level. As a third example, the comparison results, or the values within the feature vectors generated based on the comparison results, may each be compared to a corresponding threshold, and if more than a specified weighted or unweighted number exceed their thresholds, then it is concluded that print quality has degraded below a specified acceptable print quality level.

The method 100 may include responsively performing a corrective action to improve the degraded print quality of the printing device (132). The corrective action may be identified based on the identified image quality defects within the test image. There may be more than one corrective action, such as a corrective action for each ROI type, The corrective actions may include reconfiguring, including recalibrating, the printing device so that when printing source data the device is able to compensate for its degraded print quality in a way that is less perceptible in the printed output. The corrective actions may include replacing components within the printing device, such as consumable items thereof, or otherwise repairing the device to ameliorate the degraded print quality.

In one implementation, part 130 can be performed by a printing device transmitting the comparison results, or feature vectors generated based on the comparison results, to a computing device that performs the actual assessment. As such, the comparison results or generated feature vectors of a large number of similar printing devices can be leveraged by the computing device to improve print quality degradation assessment, which is particularly beneficial in the context of a machine learning technique. In another implementation, part 130 can be performed by a computing device that also compared the reference image ROIs 122 and the test image ROIs 126 and/or generated the feature vectors, Part 132 can be performed by or at the printing device itself. For instance, the identified corrective actions may be transmitted to the printing device for performance by the device.

FIG. 2A shows an example reference image 106. FIG. 2B shows an example object map 120 for the reference image 106 of FIG. 2A. The object map 120 distinguishes symbol objects 202A, a raster object 202B, and a vector object 202C within the reference image 106. That is, the object map 120 specifies the assignment of each pixel of the reference image 106 to a symbol object 202A, a raster object 202B, or a vector object 2020,

FIG. 2C shows example reference image ROIs 122B extracted from the reference image 106 of FIG. 2A using the object map 120 of FIG. 2B. The reference image ROIs 122 include symbol ROIs 122A corresponding to the symbol objects 202A of the object map 120, as well as a raster ROI 122B corresponding to the raster object 202B of the map 120. The reference image ROIs further include vector ROIs 122C and background ROIs 122D that correspond to the vector object 202C of the object map 120.

The symbol ROIs 122A, the raster ROI 122B, the vector ROIs 122C, and the background ROIs 122D can collectively be referred to as the reference image ROIs 122. Each reference image ROIs 122 is a cropped contiguous portion of the reference image 106 of an ROI type. The reference image ROIs 122 do not overlap one another; that is, each pixel of the reference image 106 belongs to at most one ROI 122. Whereas the object map 120 specifies the object 202 to which every pixel of the reference image 106 belongs, the reference image ROIs 122 each include just a subset of the pixels of the reference image 106. Further, not all the pixels of the reference image 106 may be included within any reference image ROI 122.

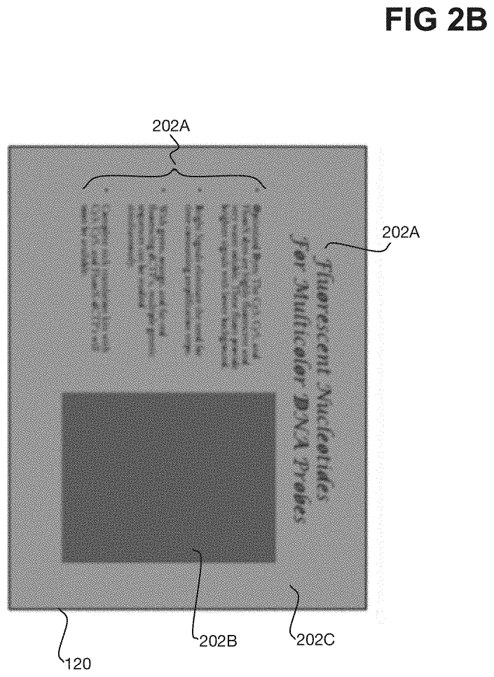

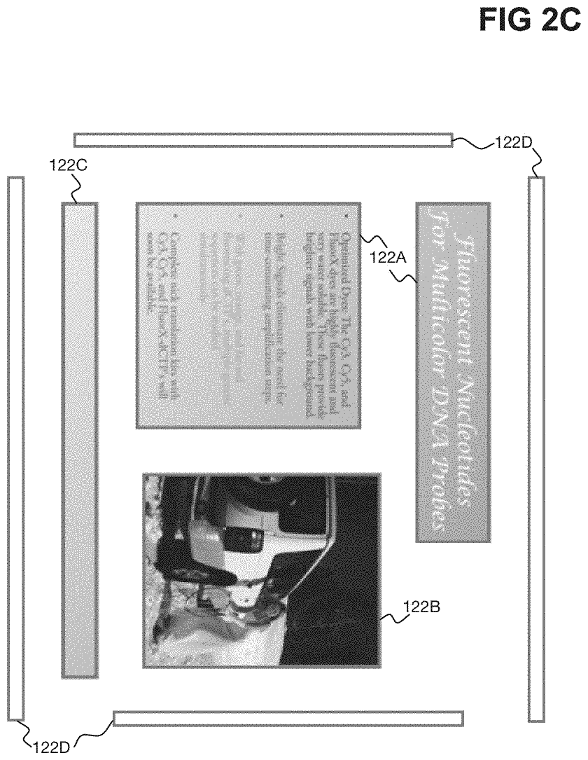

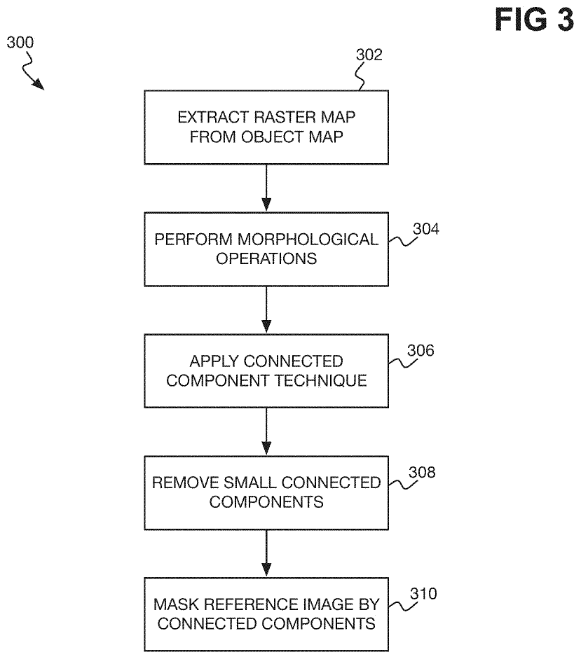

FIG. 3 shows an example method 300 for extracting raster ROIs 122B from a reference image 106. The method 300 can implement part 118 of FIG. 1 as to the raster ROI type. The raster ROIs 122B include pixel-based graphics of the reference image 106. The method 300 may be implemented as program code stored on a non-transitory computer-readable data storage medium and executed by a processor, such as that of a computing device or that of a printing device that prints the test image 112.

The method 300 can include extracting a raster map from the object map 120 (302). The object map 120 can specify whether each pixel of the reference image 106 belongs to a raster object, a symbol object, or a vector object. Extracting the raster map from the object map 120 thus considers just the pixels of the reference image 106 that belong to raster objects within the map 120.

The method 300 can include performing morphological operations on the extracted raster map (304), to compensate for imperfections within the reference image 106 due to the structure or form of the image 106. The morphological operations can include dilation and erosion, Dilation is the process of enlarging the boundaries of regions (e.g., raster objects identified in the raster map in the case of part 304) to include more pixels, whereas erosion is the process of reducing or contracting the boundaries to include fewer pixels.

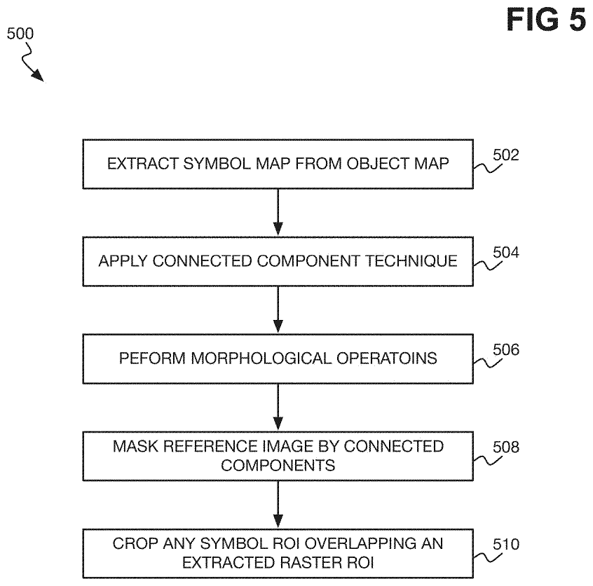

In one implementation, the boundaries of the raster objects may be subjected to morphological operations that are multiples of a specified kernel size. The kernel size may be the average height of connected components that are identified by subjecting a symbol map extracted from the object map 120 to a connected component technique, and which correspond to individual characters within the symbol map, as described later in the detailed description with reference to part 504 of FIG. 5. The morphological operations may include erosion by one kernel size, followed by dilation by six kernel size and then erosion by five kernel size. The morphological operations may result in elimination of some of the raster objects. For example, the erosion operations can result in small raster objects being eroded to the point of removal,

The method 300 can then include applying a connected component technique to the resulting raster map (i.e., to the raster objects remaining within the raster map after part 304 has been performed) (306), The connected component technique performs connected component analysis, which is a graph theory application that identifies subsets of connected components. The connected component technique is described, for instance, in H. Samet et al., “Efficient Component Labeling of images of Arbitrary Dimension Represented by Linear Bintrees,” 1988 IEEE Transactions on Pattern Analysis and Machine Intelligence, 10(4), The connected component technique is applied under specified constraints, and identifies within the raster map connected components corresponding to ROIs of the raster ROI type. The connected components are each defined as rectangular bounding boxes within the raster map in part 306.

In one implementation. there are three constraints. The first constraint is that any connected component in which raster object pixels account for more than a first threshold percentage, such as 80%, of the connected component is retained. Any connected component that does not satisfy the first constraint is subject to the second constraint; just components that do not satisfy the first constraint are subject to the second constraint. The second constraint is that any connected component in which raster object pixels account for more than a lower, second threshold percentage, such as 20%, of the component is retained so long as the connected component does not include any symbol object pixels, which are pixels belonging to symbol objects as specified by the object map 120,

Any connected component that does not satisfy the second constraint is subject to the third constraint; just components that do not satisfy the second constraint are subject to the third constraint. The third constraint is that any connected component in which raster object pixels account for more than the second threshold percentage (e.g., 20%) of the component, but that includes symbol object pixels, is retained after removing the smallest rectangular area within the component that encompasses all the symbol object pixels. Any connected component subjected to the third constraint but that does not satisfy the third constraint is discarded from further consideration.

The method 300 can also include removing from further consideration any connected components that are smaller than a threshold size (308). The threshold size can include a threshold width and a threshold height. The threshold width and threshold height can be a percentage of the total width and total height, respectively, of the reference image 106. For example, the percentage may be 10% in one implementation.

The connected components identified in part 306 by subjecting the raster map to a connected component technique under specified constraints and that remain after part 308 has been performed correspond to ROIs of the raster ROI type. The method 300 therefore includes masking the reference image 106 by the remaining connected components within the raster map to extract the reference image raster ROIs 122B (310). That is, each portion of the reference image 106 masked by a remaining connected component constitutes an extracted reference image raster ROI 122B.

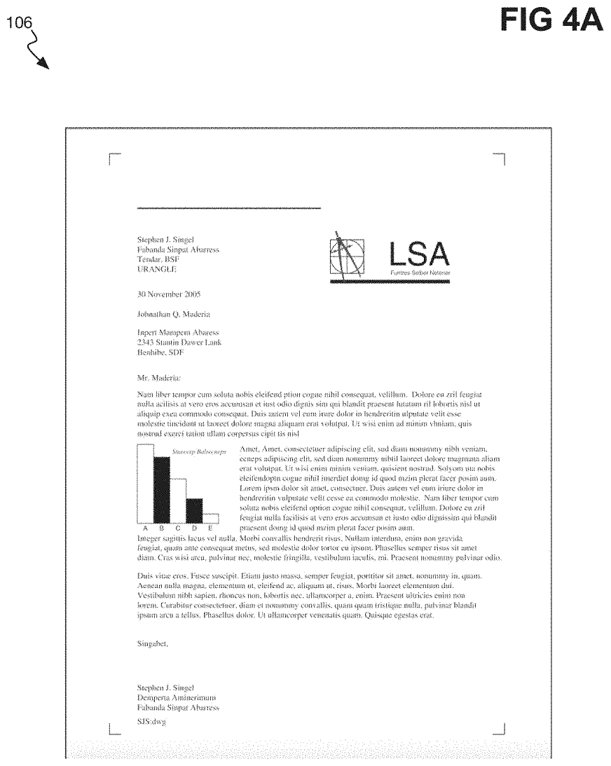

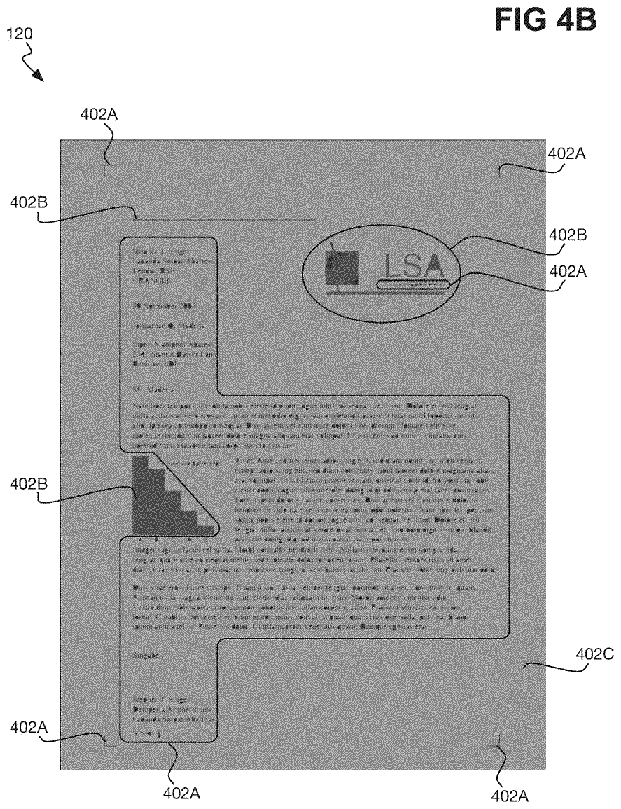

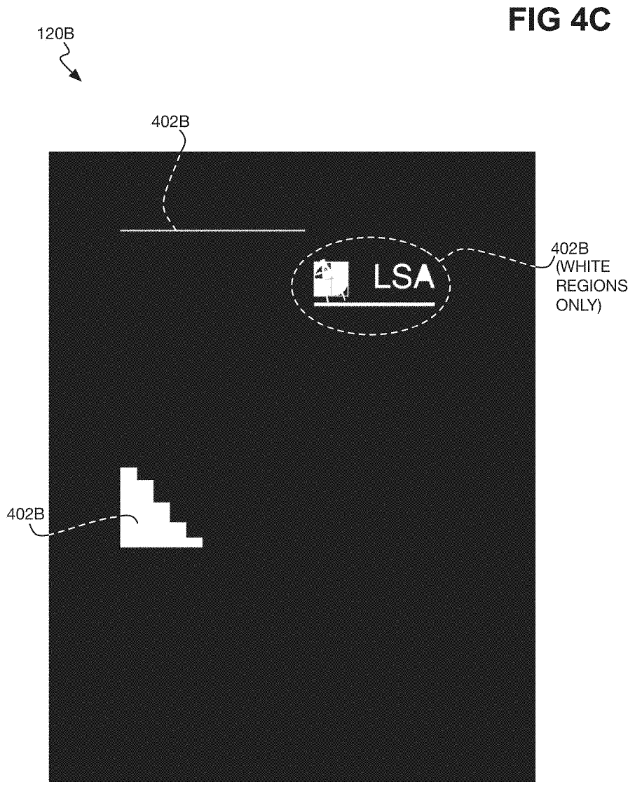

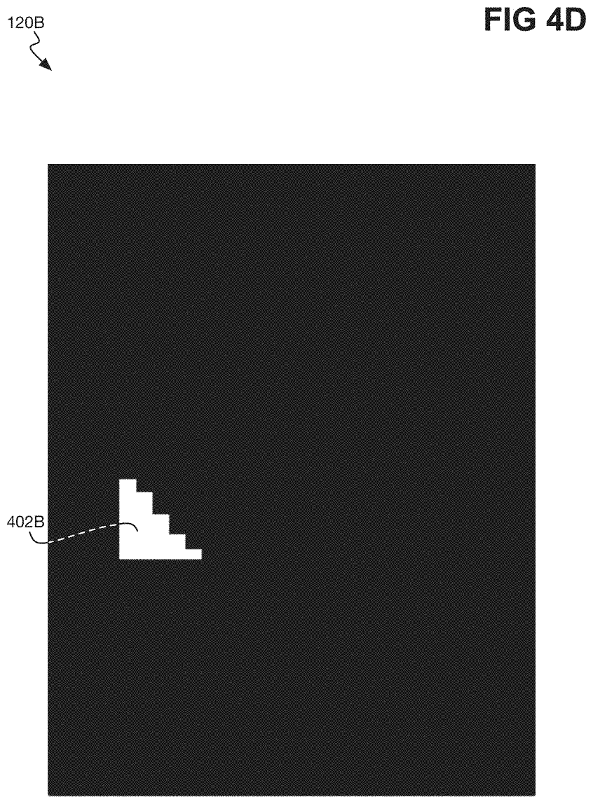

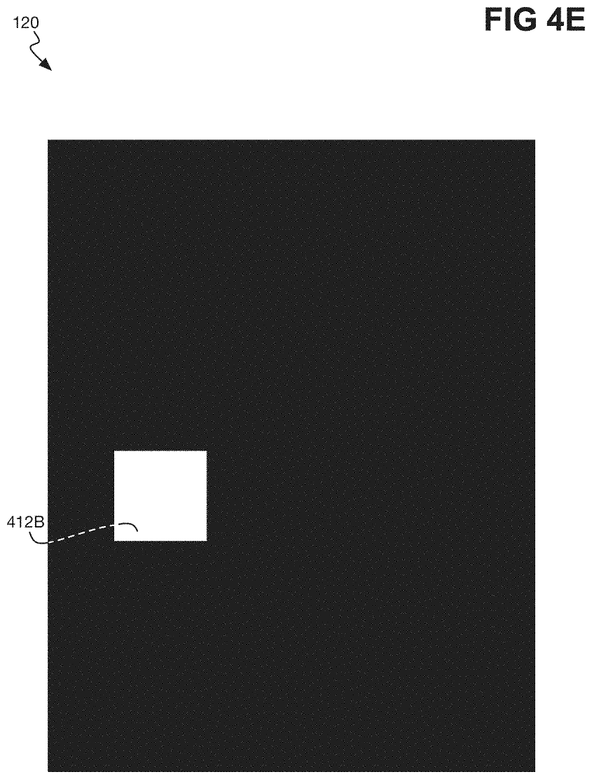

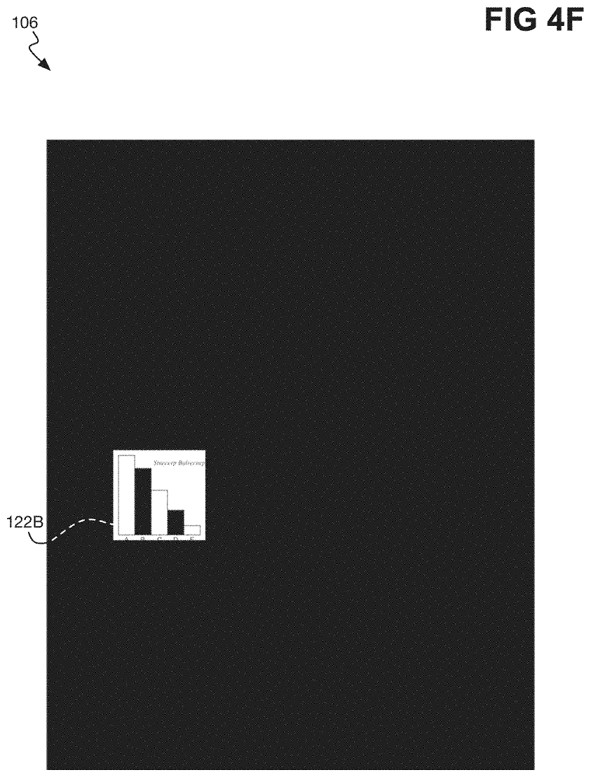

FIGS. 4A, 4B, 4C, 4D, and 4E illustratively depict example performance of portions of the method 300. FIG. 4A shows an example reference image 106, FIG. 48 shows an example object map 120 for the reference image 106 of FIG. 4A, (It is noted that the example reference image 106 and object map 120 of FIGS. 4A and 4B differ from those of FIGS. 2A and 2B.) The object map 120 distinguishes symbol objects 402A, raster objects 402B, and a vector object 4020 within the reference image 106. That is, the object map 120 specifies the assignment of each pixel of the reference image 106 to a symbol object 402A, a raster object 402B, or a vector object 402C.

FIG. 40 shows an example raster map 120E extracted from the object map 120 of FIG. 48. resulting from performance of part 302. The raster map 120E includes just the raster objects 4028 and not the symbol objects 402A and the vector object 402C. The right-most raster object 402B includes just the white regions depicted in FIG. 4C. FIG. 48 shows the raster map 120B after the morphological operations of part 304 have been performed. Just one raster object 402B thus remains within the raster map 120B.

FIG. 4E shows the connected component 412E identified within the raster map 120E of FIG. 4D after parts 306 and 308 have been performed. The connected component 412E corresponds to an ROI of the raster ROI type. FIG. 4F shows the corresponding raster ROI 122E within the reference image 106 after part 310 has been performed. Application of the method 300 to the reference image 106 of FIG. 4A thus culminates in extraction of the reference image raster ROI 122B of FIG. 4F.

FIG. 5 shows an example method 500 for extracting symbol ROIs 122A from a reference image 106. The method 500 can implement part 118 of FIG. 1 as to the symbol ROI type. The symbol ROIs 122A include text and other symbols of the reference image 106, The method 500 may be implemented as program code stored on a non-transitory computer-readable data storage medium and executed by a processor, such as that of a computing device or that of a printing device that prints the test image 112.

The method 500 can include extracting a symbol map from the object map 120 (502). The object map 120 can specify whether each pixel of the reference image 106 belongs to a raster object, a symbol object, or a vector object. Extracting the symbol map from the object map 120 thus considers just the pixels of the reference image 106 that belong to symbol objects within the map 120.

The method 500 can include applying a connected component technique on the extracted symbol map (504). Application of the connected component technique to the extracted symbol map identifies connected components within the map. The connected components may correspond to individual characters of text and other symbols within the extracted symbol map. The individual characters (i.e., the individual connected components) each have a height.

The method 500 can include performing morphological operations on the identified connected components (506). The morphological operations can include dilating the connected components to merge them into a smaller number of connected components. For instance, prior to dilation, the connected components may correspond to individual characters, whereas after dilation, the connected components may correspond to paragraphs or other regions including multiple characters,

The kernel size by which each connected component is dilated in the horizontal and vertical directions may be equal to the average horizontal and vertical distances, respectively, between adjacent connected components. Adjacent characters within words are separated by horizontal distances. Each distance may be specified from left character edge to left character edge, right character edge to right character edge, or horizontal character center to horizontal character center. The average of these distances may be the kernel size by which each connected component is horizontally dilated, both to the left and the right.

Adjacent characters within consecutive lines are separated by vertical distances. Each distance may be specified from typographical baseline to baseline, from typographical cap height to cap height, or from typographical ascender height to ascender height, The typographical baseline of a line of text is the bottom line at which characters that do not have descenders (e.g., the bottom parts of letters like “g,” “y,” and so on) are aligned, and at which the non-descender portions of characters that do have descenders are aligned. The typographical cap height of a line of text is the topmost line at which capitalized characters are aligned. The typographical ascender height of a line of text is the topmost line at which the ascenders (e.g., the top parts of letters like “f,” “h, ” and so on) of characters that have such ascenders are aligned. The typographical cap and ascender heights may be collinear. The average of these distances may be the kernel size by which each connected component is vertically dilated both above and below.

Another morphological operation that can be performed may be considered the rectangularization of the merged connected components. Each merged connected component may not be in the form of a rectangle, due to how the characters are formatted or justified on the page. Rectangularization thus transforms each connected component into the smallest sized rectangle including the entirety of the connected component. That is, it may be said that the bounding box of each merged connected component is considered for the remainder of the method 500.

The merged connected components that result from dilation and rectangularization in part 506 correspond to ROIs of the symbol ROI type. The method 500 therefore includes masking the reference image 106 by the merged connected components within the symbol map to extract the reference image symbol ROIs 122A (508). That is, each portion of the reference image masked by a merged connected component constitutes an extracted reference image symbol ROI 122A,

Because the merged connected components have been rectangularized, the corresponding reference image symbol ROIs 122A may overlap reference image raster ROIs 122B that were previously extracted, such as pursuant to the method 300 of FIG. 3. Since the reference image ROIs 122 should not overlap one another, any symbol ROI 122A that overlaps an extracted raster ROI 122B is cropped to remove the overlapping (510). Cropping is performed such that the cropped reference image symbol ROI 122A remains rectangular.

Cropping can be performed by removing a rectangular portion of a symbol ROI 122A at the left or right edge, where the removed rectangular portion is equal in height to the symbol ROI 122A and has a smallest width that encompasses the overlapped portion of a raster ROI 122B. Cropping can instead by performed by removing a rectangular portion of the symbol ROI 122A at the top or bottom edge, where the removed rectangular portion is equal in width to the symbol ROI 122A and has the smallest height that encompasses the overlapped portion of the ROI 122B, Whether cropping occurs at the left or right edge or at the top or bottom edge may be controlled by which approach results in the smallest rectangular portion being removed from the symbol ROI 122A.

The removed portion from the symbol ROI 122A can be more extensive than the overlapped portion of the raster ROI 122B. That is, the portion removed from the symbol ROI 122A can include text and other symbols, in addition to the actual overlapped portion of the raster ROI 1228 that includes pixel-based graphics. Removal of such text and other symbol removal occurs so that the cropped symbol ROI 122A remains rectangular.

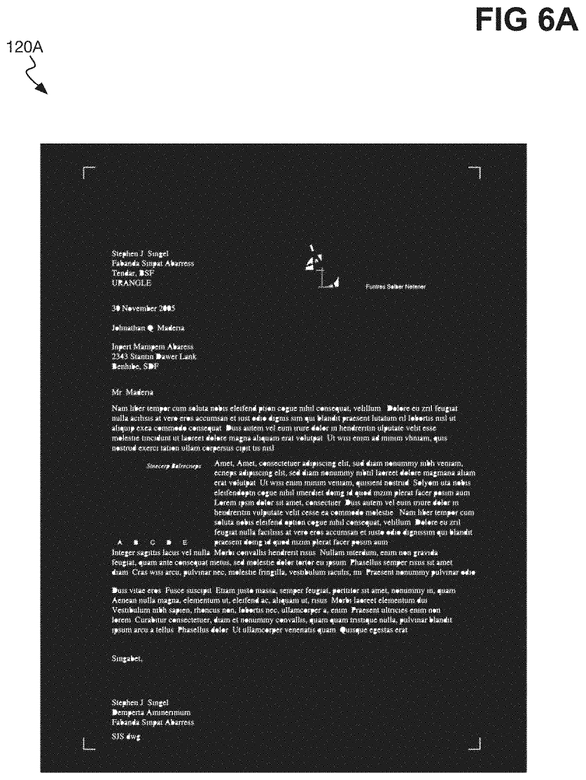

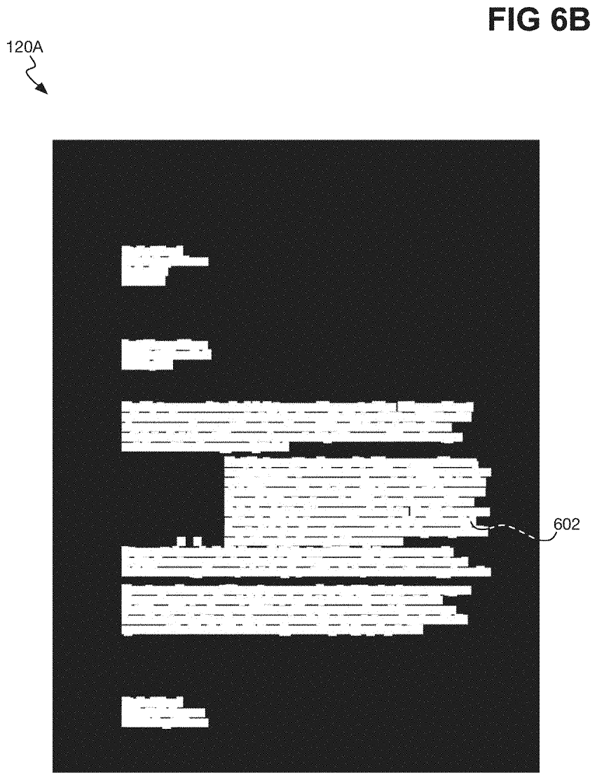

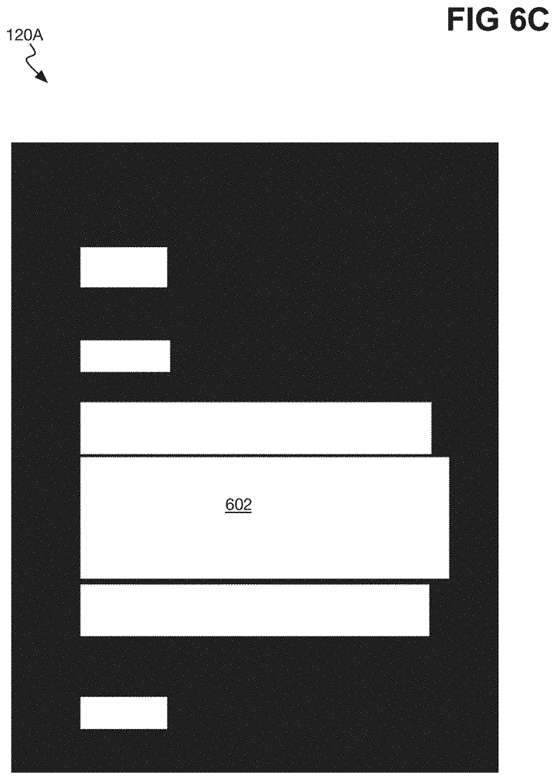

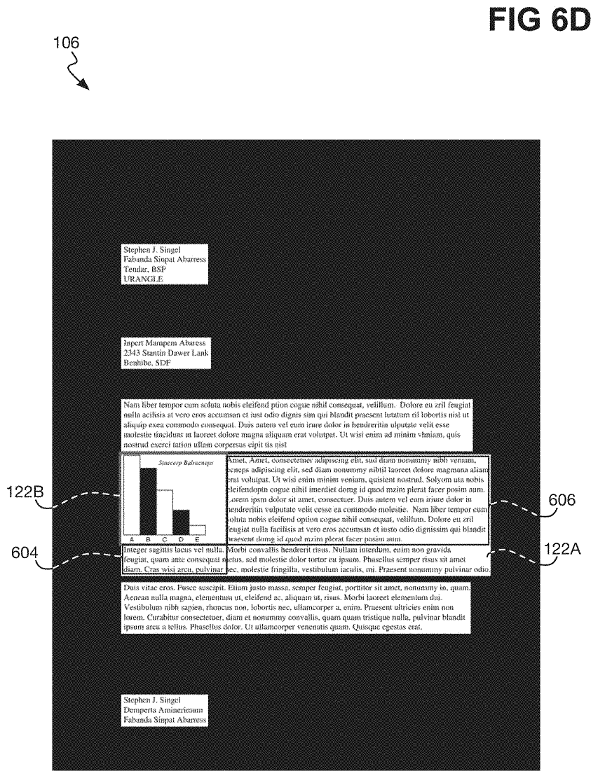

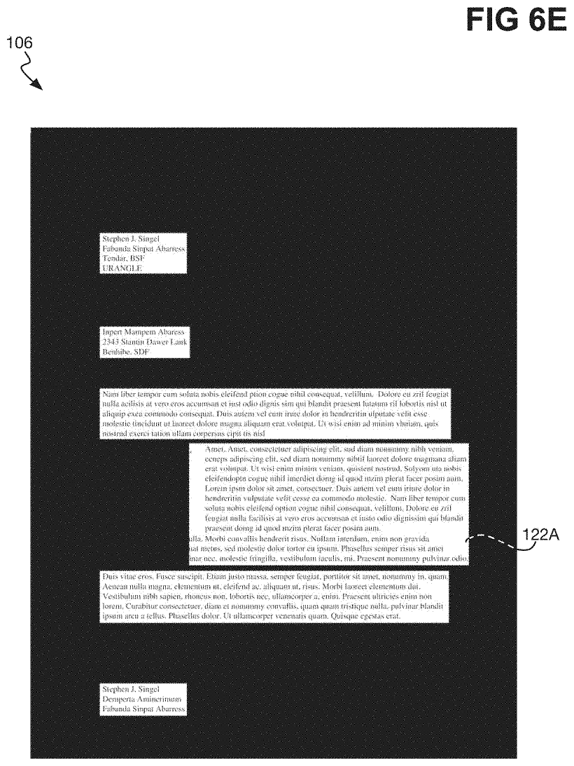

FIGS. 6A, 6B, 6C, 6D, 6E, and 6F illustratively depict example performance of portions of the method 500. FIG. 6A shows an example symbol map 120A extracted from the object map 120 of FIG. 4B for the reference image 106 of FIG. 4A. The symbol map 120A includes just symbol objects, which are identified in white.

FIG. 6B shows the symbol map 120A after the connected component technique has been applied in part 504 and after dilation has been performed in part 506. There are thus five merged connected components 602 in FIG. 6B. FIG. 6C shows the symbol map 120A after rectangularization has been performed in part 506. Each connected component 602 has been rectangularized in FIG. 6C, and corresponds to an ROI of the symbol ROI type.

FIG. 6D shows the corresponding symbol ROIs 122A within the reference image 106 after part 508 has been performed. The symbol ROI 122A specifically called out in FIG. 6D overlaps a previously extracted raster ROI 122B. Therefore, this symbol ROI 122A is cropped, Cropping can potentially occur by removing a rectangular portion at the left edge of the symbol ROI 122A including the raster ROI 122B and a symbol region 604, or by removing a rectangular portion at the top edge including the raster ROI 122B and a symbol region 606.

The symbol region 604 is smaller than the symbol region 606. Therefore, cropping is performed at the left edge of the symbol ROI 122A, instead of at the top edge, which results in removal of the rectangular portion including the raster ROI 122B and the symbol region 604. FIG. 6E shows the corresponding symbol ROIs 122A within the reference image 106 after part 510 has been performed. The symbol ROI 122A specifically called out in FIG. 6E no longer includes the previously extracted raster ROI 122B as a result of the cropping of part 510.

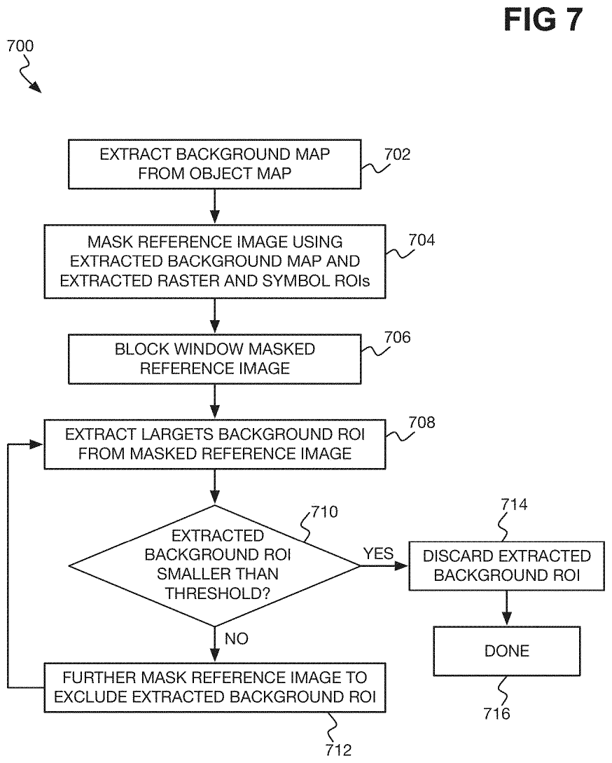

FIG. 7 shows an example method 700 for extracting background ROIs 122D from a reference image 106. The method 700 can implement part 118 of FIG. 1 as to the background ROI type. The background ROIs 122D include uniform white areas of the reference image 106. The method 700 may be implemented as program code stored on a non-transitory computer-readable data storage medium and executed by a processor, such as that of a computing device or that of a printing device that prints the test image 112.

The method 700 can include extracting a background map from the object map 120 (702). The object map 120 can specify whether each pixel of the reference image 106 belongs to a raster object, a symbol object, or a vector object. Extracting the background map from the object map 120 thus considers just the pixels of the reference image 106 that belong to vector objects within the map 120 that are uniform white areas, as opposed to, for instance, vector objects that are uniform non-white and smooth gradient color areas.

The method 700 can include masking the reference image 106 using the extracted background map as well as already extracted reference image raster and symbol ROIs 122B and 122A (704), which may have been identified using the methods 300 and 500 of FIGS. 3 and 5. The reference image 106 is masked using the extracted background map to remove or exclude from further consideration areas of the image 106 that do not correspond to the background map. The reference image 106 is similarly masked using the raster and symbol ROIs 122B and 122A to remove from further consideration areas of the image 106 that correspond to the raster and symbol ROIs 122B and 122A.

The method 700 can include block windowing the masked reference image 106 (706). In one implementation, the background ROIs 122D to be extracted from the reference image 106 are rectangular. Block windowing the reference image 106 reduces the computational intensity in extracting such rectangular background ROIs 122D. Block windowing is the process of overlaying a rectangular grid onto the masked reference image 106. Any rectangle of the grid that overlaps an area that has been removed from further consideration within the reference image 106 during the masking process of part 704 is itself removed or excluded from consideration during subsequent extraction of background ROIs 122D. For example, the rectangles of the grid may be squares that are 300-by-300 pixels in size.

The method 700 can in one implementation then extract the background ROIs 122D from the masked and block-windowed reference image 106 using a greedy approach, in which background ROIs 122D are iteratively extracted from largest to smallest until all such background ROIs 122D greater than a threshold size have been identified. The method 700 can thus include extracting the largest background ROI 122D from the masked and block-windowed reference image 106 (708). Different techniques may be employed to extract the largest background ROI 122D, and which may differently define the largest background ROI 122D within the reference image 106. Both a chessboard technique identifying a deepest background ROI 122D and an accumulation matrix technique identifying a maximum background ROI 122D are described later in the detailed description as example such techniques to extract the largest background ROI 122D from the reference image 106.

If the background ROI 122D that has just been extracted via the most recent performance of part 708 is no smaller than the threshold size (710), then the reference image 106 is further masked to exclude this extracted ROI 122D from further consideration in extracting the next background ROI 122D from the reference image 106 (712). Because the reference image ROIs 122 are non-overlapping, such masking in part 712 ensures that subsequently extracted background ROIs 122D will not overlap already extracted ROIs 122. The method 700 is then repeated at part 708 to extract the largest background ROI 122D from the reference image 106.

However, if the background ROI 122D that has just been extracted via the most recent performance of part 708 is smaller than the threshold size (710), then it is discarded (714). The most recently extracted background ROI 122D is discarded since it is of insufficient size as compared to the threshold. The method 700 is therefore finished (716). The iterative process of parts 708, 710, and 712 thus identifies increasingly smaller-sized background ROIs 122D from the reference image 106.

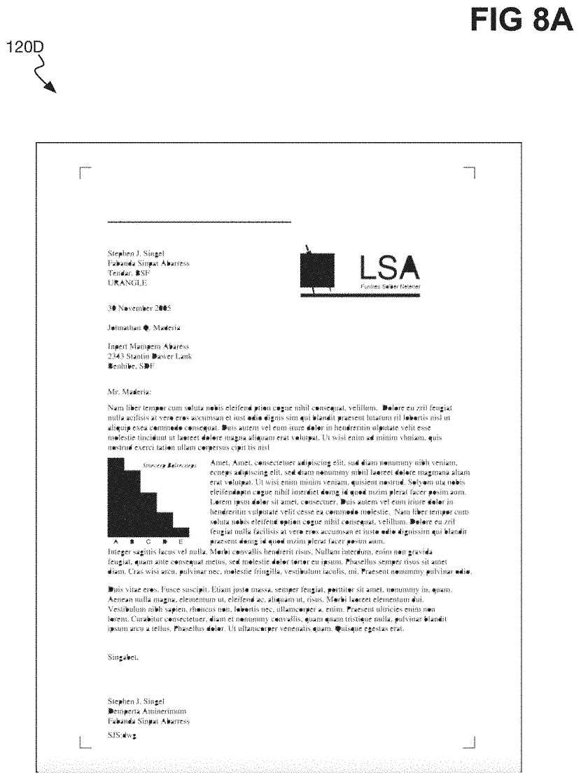

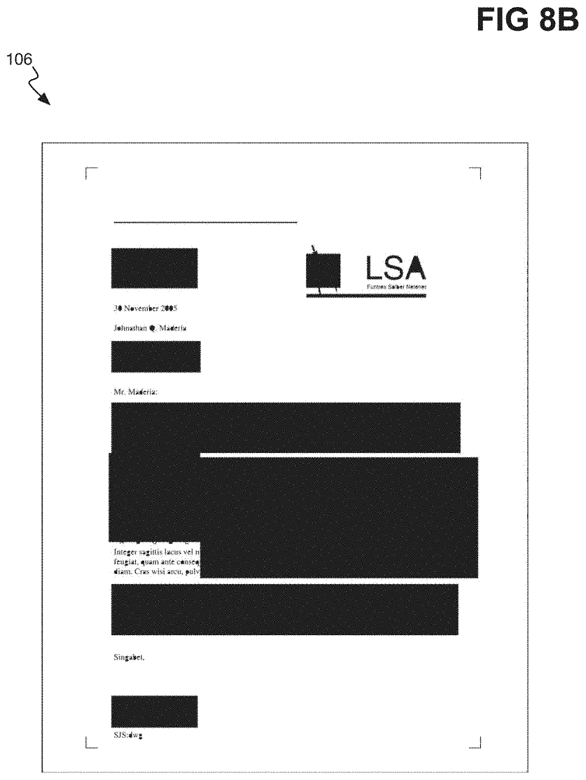

FIGS. 8A, 8B, and $C illustratively depict example performance of portions of the method 700. FIG. 8A shows an example background map 120D extracted from the object map 120 of FIG. 4B for the reference image 106 of FIG. 4A. The background map 120D includes just background objects, which are identified in white.

FIG. 8B shows the reference image 106 after it has been masked in part 704 using the background map 120D, the extracted raster ROI 122E of FIG. 4F, and the extracted symbol ROI 122A of FIG. 6E. The black regions in FIG. 8B indicate the regions removed or excluded from further consideration, corresponding to the black regions of the background map 120D and to the extracted raster and symbol ROIs 122E and 122A. FIG. 8C shows the masked reference image 106 after it has been block windowed in part 706. The background ROIs 122D are thus extracted from the white regions of FIG. 8C.

As noted above, besides a background ROI type, the vector object type of the object map 120 can have another corresponding ROI type: a vector ROI type including just uniform non-white and smooth gradient color areas, as opposed to the uniform white areas of the background ROI type. Extraction of reference image vector ROIs 122C can be performed in a manner similar to that of the method 700, but with respect to a vector map extracted from the object map 120. The vector map identifies pixels belonging to vector objects of uniform non-white and smooth gradient color areas, as compared to the background map that identifies pixels belonging to background objects of uniform white areas.

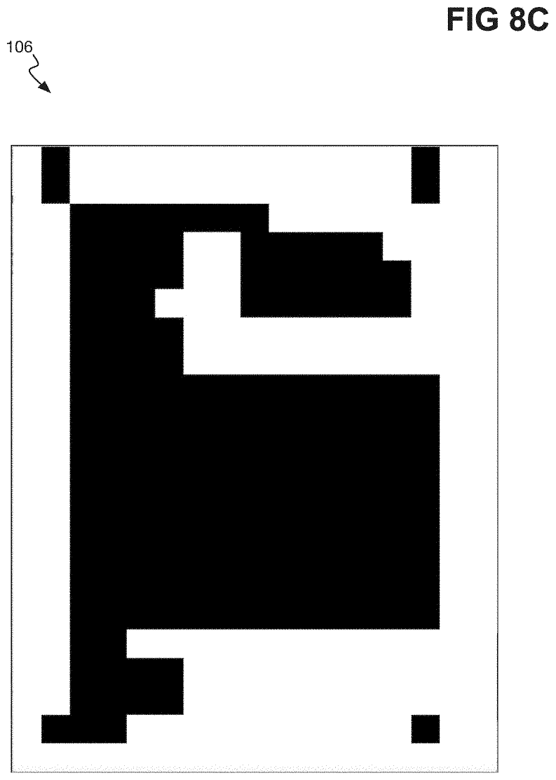

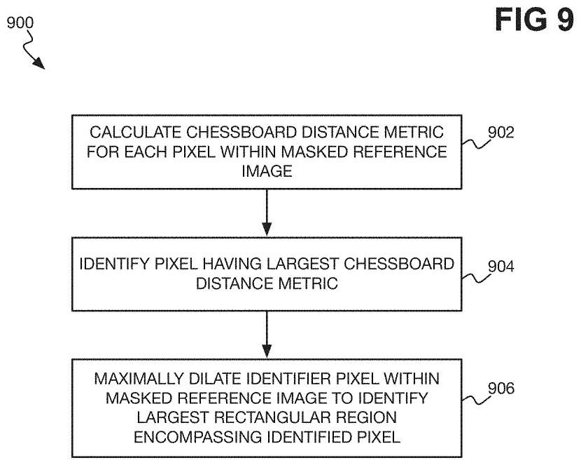

FIG. 9 shows an example method 900 for extracting a deepest background ROI 122D from the reference image 106 using a two-dimensional chessboard technique. The method 900 can implement part 708 of FIG. 7 to extract the largest background ROI 122D, as the deepest background ROI 122D. The method 900 can be implemented as program code stored on a non-transitory computer-readable data storage medium and executed by a processor. The processor may be part of a computing device or a printing device that prints the test image 112.

The method 900 can include calculating a chessboard distance metric for each pixel within the masked (and block-windowed) reference image 106 (902). The chessboard distance metric is described in A. Meijster et al., “A General Algorithm for Computing Distance Transforms in Linear Space,” in Mathematical Morphology and its Applications to image and Signal Processing (2002). The chessboard distance metric is a metric defined on a vector space, in which the distance between two vectors is the greatest of their differences along any coordinate dimension. For example, the chessboard distance between two points having coordinates (x₁y₁) and (x₂ y₂) is max( |x₁−x₂|,|y₁−y₂|). As to part 902, the chessboard distance metric for a pixel within the masked (and block-windowed) reference image is the largest chessboard distance between the pixel and any other pixel within the image 106.

The method 900 can thus include identifying the pixel having the largest chessboard distance metric (904). if more than one pixel have the same largest chessboard distance metric, then any pixel within the largest contiguous group of such pixels can be selected, The method 900 may then include maximally dilating the identified pixel within the masked (and block-windowed) reference image 106 to identify the largest rectangular region that encompasses the pixel (906), as the deepest reference ROI 122D within the image 106.

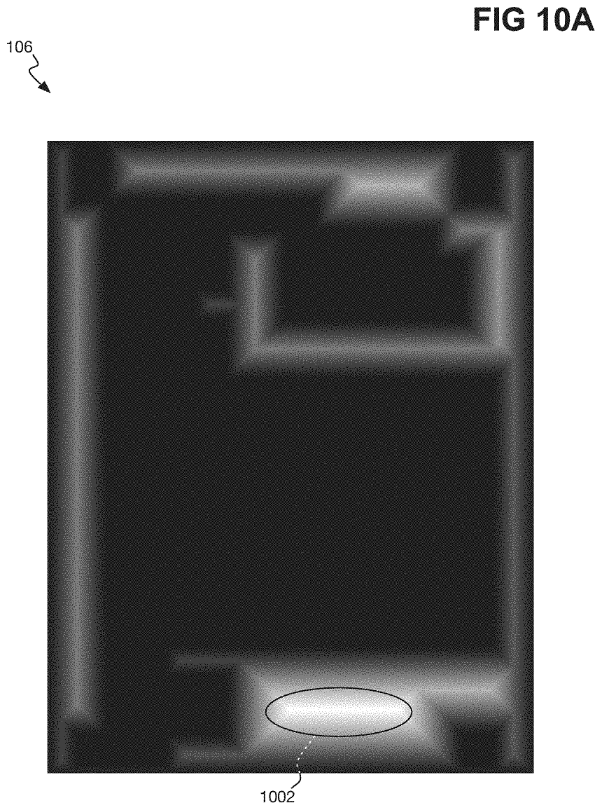

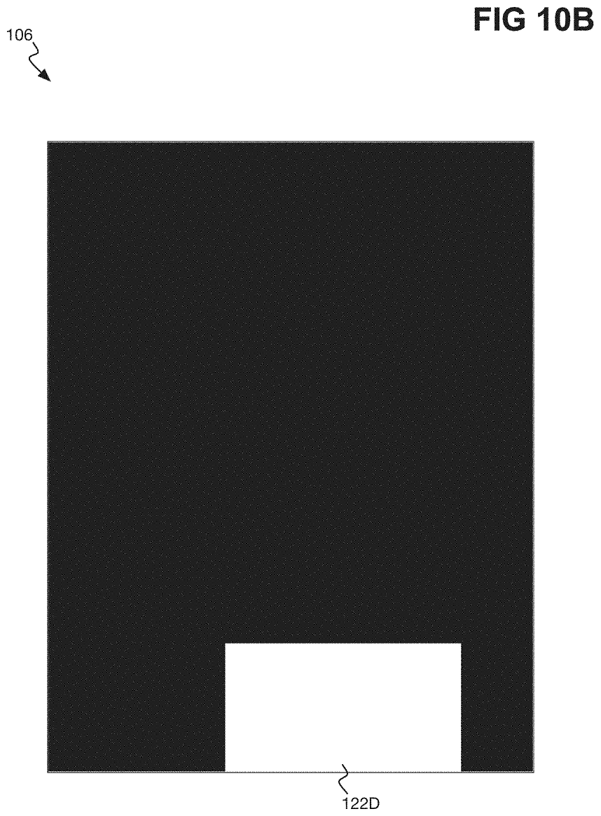

FIGS. 10A and 10B illustratively depict example performance of portions of the method 900. FIG. 10A graphically denotes the chessboard distance metrics for the pixels of the masked and block-windowed reference image 106 of FIG. 8C. The color of each pixel ranges from black to white. Pixels that have been discarded for consideration and pixels that have the lowest chessboard distance metrics are in black in FIG. 10A, whereas pixels having the highest chessboard distance metrics are in white. The lightness of each gray pixel in FIG. 10A corresponds to the pixel's chessboard distance metric, with lighter pixels having higher metrics than darker pixels.

The pixels within the region 1002 in FIG. 10A are in white, and thus have the highest chessboard distance metrics. These pixels are contiguous to one another, and therefore any pixel within the region 1002 is selected in part 904 as the identified pixel. FIG. 10B shows the corresponding deepest background ROI 122D within the reference image 106 after the identified pixel has been maximally dilated in part 906.

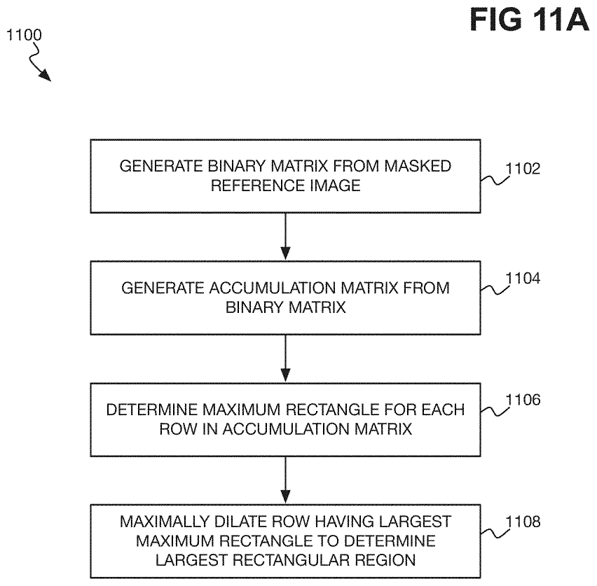

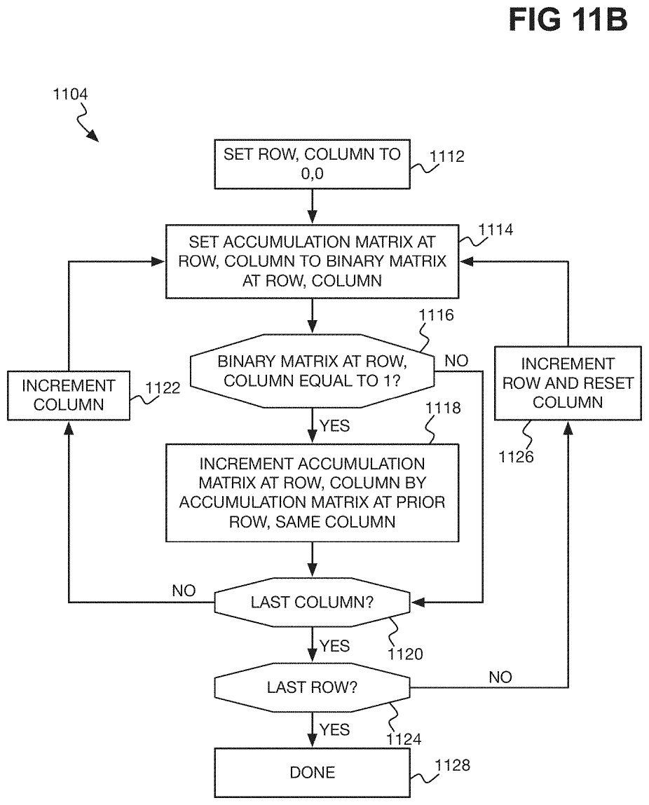

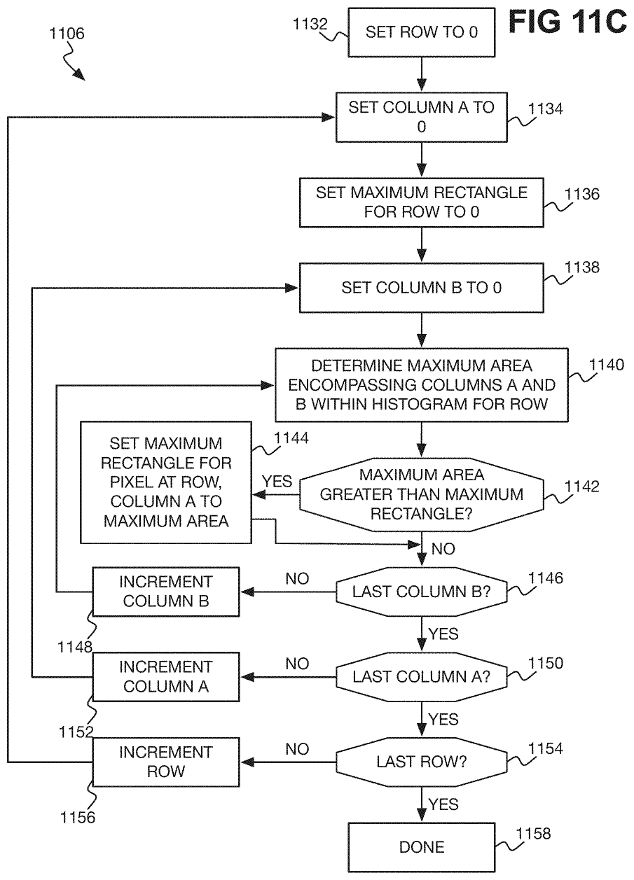

FIGS. 11A, 11B, and 11C show an example method 1100 for extracting a maximum ROI 122D from the reference image 106 using an accumulation matrix technique. The method 1100 can implement part 708 of FIG. 7 to extract the largest background ROI 122D, as the maximum ROI 122D. The method 1100 can be implemented as program code stored on a non-transitory computer-readable data storage medium and executed by a processor. The processor may be a part of a computing device or a printing device that prints the test image 112.

The method 1100 can include generating a binary matrix from the masked (and block .windowed) reference image 106 (1102). The binary matrix corresponds to the reference image 106. Each pixel of the image 106 that has not been discarded from consideration due to masking or bock-windowing has a corresponding value of one in the binary matrix. Each pixel that has been discarded from consideration has a corresponding value of zero in the binary matrix.

The method 1100 can include generating an accumulation matrix from the binary matrix (1104), The value at each pixel (i.e. position) within the accumulation matrix corresponding to a pixel within the binary matrix having a value of one is the value at the immediately above pixel within the accumulation matrix, plus one. The value at each pixel within the accumulation matrix corresponding to a pixel within the binary matrix having a value of zero is zero. How the accumulation matrix can be generated is described in more detail later in the detailed description.

The method 1100 can include determining a maximum rectangle for each row of pixels (i.e., each row of positions) in the accumulation matrix (1106). The maximum rectangle for a row in the accumulation area is the area of the largest rectangle encompassing the values of any two pixels within that row, in a histogram of the values for the pixels within the row. That is, the maximum rectangle is the area of the largest rectangle that can fit within the histogram. How the maximum rectangle can be determined is described in more detail later in the detailed description.

The method 1100 can then include maximally dilating the corresponding row within the masked (and block-windowed) to identify the largest rectangular region (1108), as the maximum background ROI 122D within the image 106. The dilation operation can begin with the pixel of this row that is at the center, width-wise, of the maximum rectangle. If the maximum rectangle has an even number of pixels in width, such that no pixel of the row is at the center of the width of the maximum rectangle, then the dilation operation can begin with either pixel of the row that is closest to the center of the maximum rectangle's width.

FIG. 11B shows an example process for generating the accumulation matrix in part 1104. Row and column indices are both initially set to zero (1112). The value of the accumulation matrix at the position identified by the row and the column is initially set to the value of the binary matrix at the corresponding position (1114). If the binary matrix at this corresponding position is equal to one (1116), then the accumulation matrix at the position is incremented by the value of the binary matrix at the position immediately above (1118).

If the last column has not yet been processed for the current row (i.e., the row identified by the row index) (1120), then the column index is incremented (1122), and the process is repeated at part 1114. Once the last column has been processed for the current row (1120), if the last row has not yet been processed (1124), then the row index is incremented and the column index is reset to zero (1126), and the process is repeated at part 1114. The process ends once all the columns have been processed for every row (1128).

FIG. 11C shows an example process for generating the maximum rectangle for each row of the accumulation matrix in part 1106. A row index is initially set to zero (1132), as is a first column index (1134), which is referenced as column A in FIG. 11C. The maximum rectangle for the current row is set to zero (1136). A second column index, which is referenced as column B in FIG. 11C, is also set to zero (1138).

The maximum area that encompasses columns identified by the two column indices within the histogram plotting the values for the pixels within the current row (i.e., the row identified by the row index) is determined (1140). If this maximum area is greater than the maximum rectangle determined thus far for the current row (1142), then the maximum rectangle for the current row is set to the maximum area (1144). In either case, if the second column index does not refer to the last column (1146), then the second column index is incremented (1148), and the process is repeated at part 1140.

Once the second column index references the last column (1146), if the first column index does not refer to the last column (1150), then the first column index is incremented (1152), and the process is repeated at part 1138. Once the first column index references the last column (1150), then the current row has been processed, If the row index does not reference the last row (1154), then the row index is incremented (1156), and the process is repeated at part 1134. Once the row index references the last row, then all the rows have been processed, and the process of FIG. 11C is finished (1158).

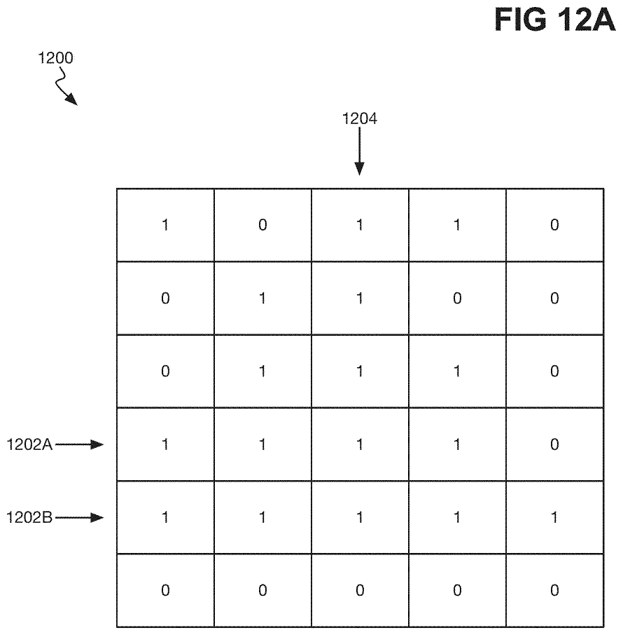

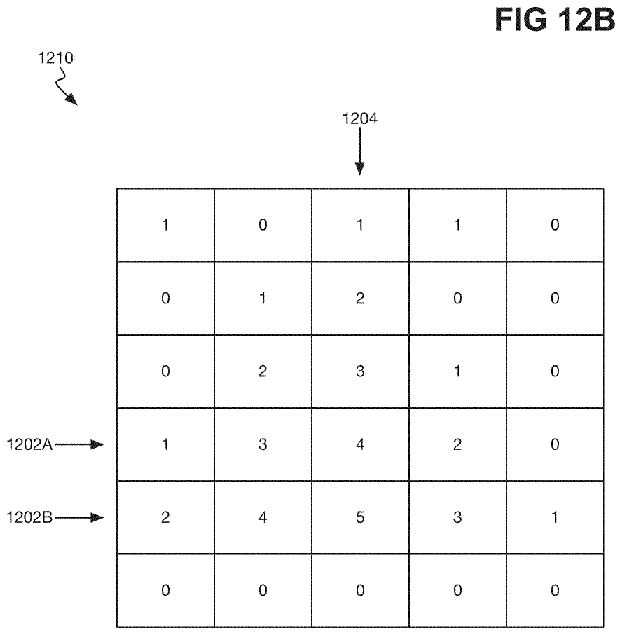

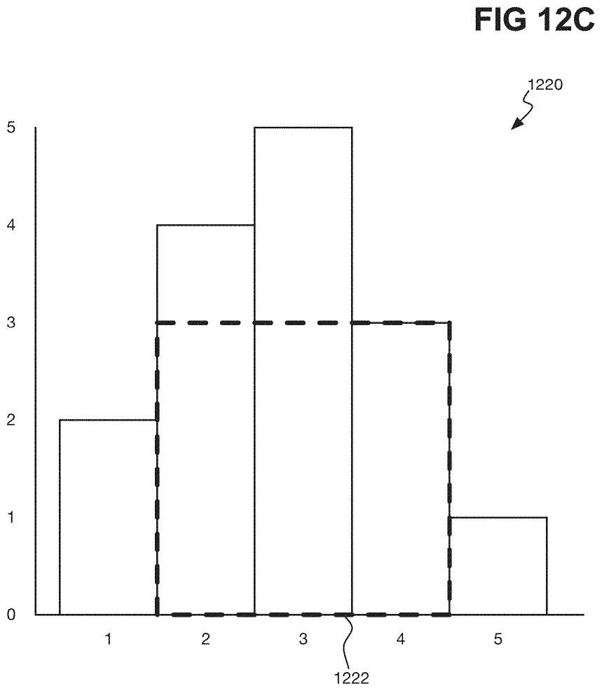

FIGS. 12A, 12B, and 12C illustratively depict example performance of portions of the method 1100. FIG. 124 shows an example binary matrix 1200 for a five pixel-by-five pixel portion of the masked and block-windowed reference image 106 of FIG. 8C, which can be generated by performing part 1102. The binary matrix 1200 at each pixel, or position, is equal to one if the reference image 106 has not been masked or block-windowed off at the corresponding pixel. The binary matrix 1200 at each pixel is equal to zero if the reference image 106 has been masked or block-windowed off at the corresponding pixel.

Two specific rows 10A and 10B as well as one specific column 1204 are called out in FIG. 12A.

FIG. 12B shows an example accumulation matrix 1210 for the binary matrix 1200 of FIG. 12A that can be generated by performing part 1104. The accumulation matrix 1210 at each pixel corresponding to a pixel within the binary matrix 1200 that is equal to one is the value of the pixel in the same column but the preceding row in the accumulation matrix 1210, plus one. The accumulation matrix 1210 at each pixel corresponding to a pixel within the binary matrix 1200 that is equal to zero is zero.

For example, the pixel within the accumulation matrix 1210 at the row 1202B and column 1204 corresponds to a pixel within the binary matrix 1200 at the same row 1202B and column 1204 having a value of one. Therefore, the pixel within the accumulation matrix 1210 at this row 1202B and column 1204 is equal to five. This is because the pixel within the accumulation matrix 1210 at the preceding row 1202A but the same column 1204 is equal to four, which is then incremented by one to yield the value of the pixels within the matrix 1210 at the row 1202B and column 1204.

FIG. 120 shows an example histogram 1220 of the values of the pixels within the row 1202B of the accumulation matrix 1210 of FIG. 12B. The five bars of the histogram 1220 thus correspond to the five values two, four, five, three, and one of the pixels within this row 1202B in the matrix 1210. The maximum rectangle 1222 that can fit within the histogram 1220 is called out in FIG. 12C, and can be identified by performing part 1106, The maximum rectangle 1222 is centered width-wise at the bar within the histogram 1220 that has the value of five, Therefore, dilation in part 1108 can start with the corresponding pixel within the reference image 106, which is at column 1204 within the row 1202B.

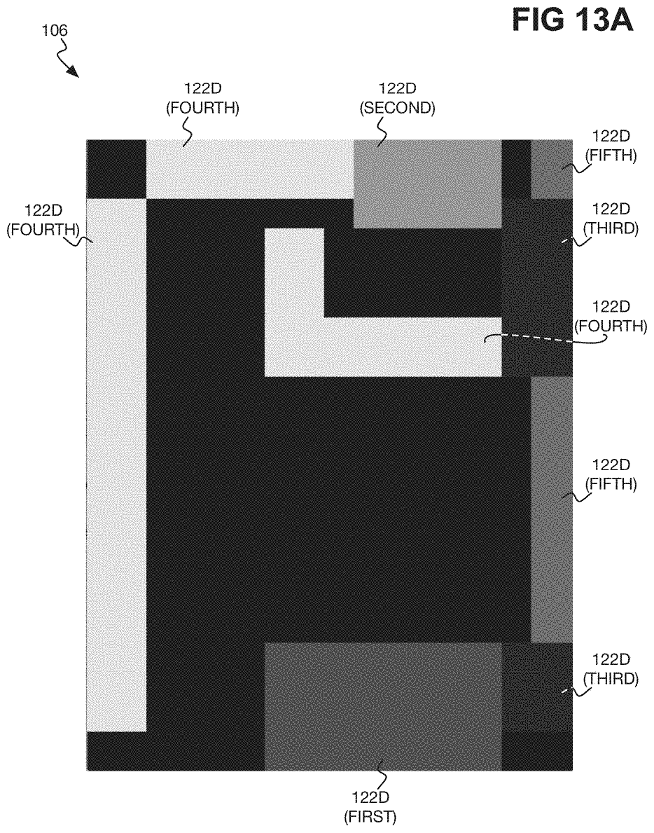

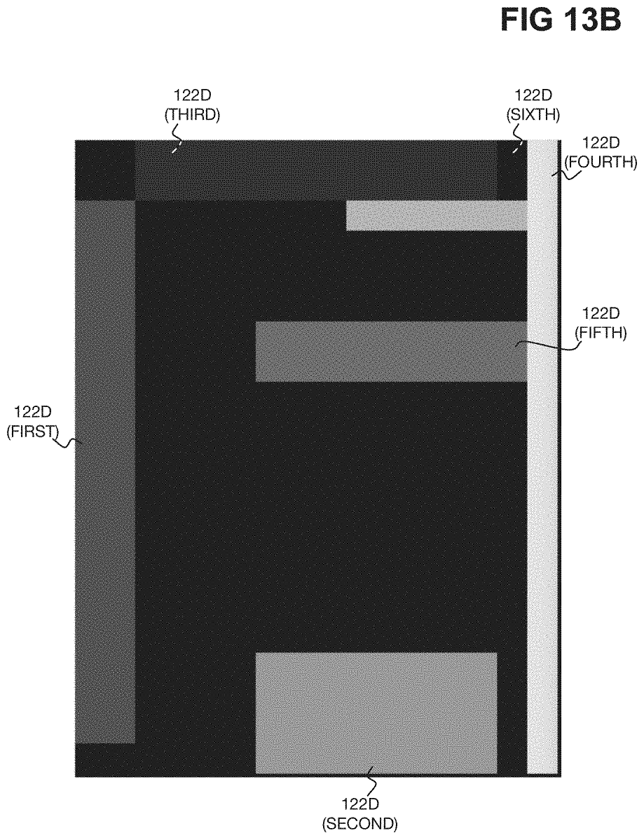

FIGS. 13A and 13B show example performance of the method 700 of FIG. 7 in which the background ROIs 122D have been extracted from the reference image 106 respectively using the described chessboard distance and accumulation matrix techniques. FIG. 13A shows the extracted reference image background ROIs 122D using the chessboard distance matrix technique of FIG. 9, FIG. 13B shows the extracted reference image background ROIs 122D using the accumulation matrix technique of FIGS. 11A, 11B, and 11C.

The background ROIs 122D are each parenthetically identified in FIGS. 13A and 13B by which iteration of parts 708, 710, and 712 of FIG. 7 it was extracted from the reference image 106. That is, the background ROIs 122D identified by “(FIRST)” were extracted in the first iteration of parts 708, 710, and 712; the background ROIs 122D identified by “(SECOND)” were extracted in the second iteration of parts 708, 710, and 712; and so on. In the example of FIGS. 13A and 13B, more than one background ROI 122D has been extracted in each iteration. Furthermore in AG. 13A, the apparently L-shaped background ROI 122D is actually two rectangular background ROIs 122D side-by-side, since ROIs 122 are rectangular in shape.

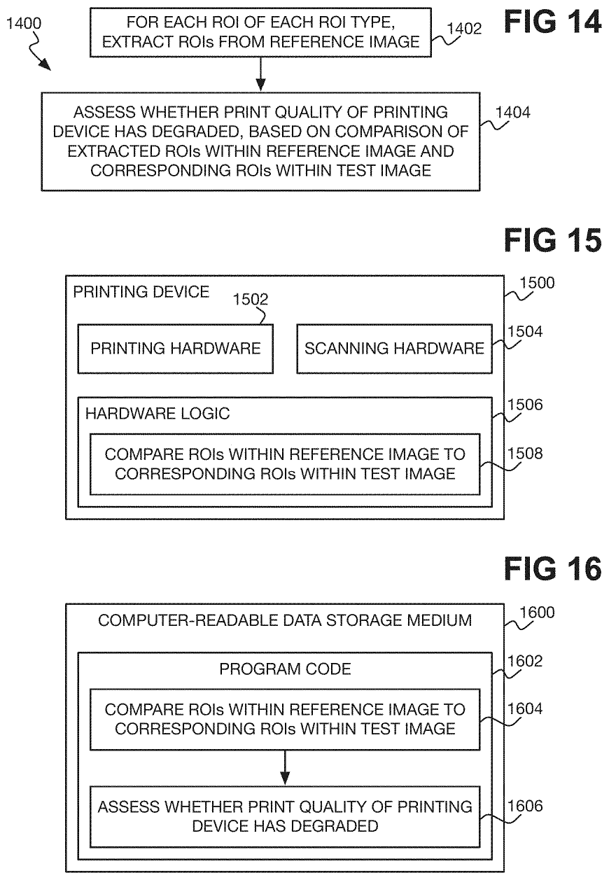

FIG. 14 shows an example method 1400. The method 1400 can be performed by a processor, such as that of a computing device or a printing device. The method 1400 includes, for each of a number of ROI types, extracting ROIs of the ROI type from a reference image based on an object map distinguishing symbol, raster, and vector objects within the reference image (1402). The method 1400 includes assessing whether print quality of a printing device has degraded below a specified acceptable print quality level, based on a comparison of the extracted ROIs within the reference image to corresponding ROIs within a test image corresponding to the reference image and printed by the printing device (1404).

FIG. 15 shows an example printing device 1500. The printing device 1500 includes printing hardware 1502 to print a test image corresponding to a reference image having ROIs of a number of ROI types. For example, in the case of an EP printing device, the printing hardware may include those components, such as the OPC, ITB, rollers, a laser or other optical discharge source, and so on, that cooperate to print images on media using toner. The printing device 1500 includes scanning hardware 1584 to scan the printed test image. The scanning hardware 1584 may be, for instance, an optical scanning device that outputs differently colored light onto the printed test image and detects the colored light as responsively reflected by the image.

The printing device 1500 includes hardware logic 1506. The hardware logic 1506 may be a processor and a non-transitory computer-readable data storage medium storing program code that the processor executes. The hardware logic 1506 compares the ROIs of each ROI type within the reference image to corresponding ROIs within the scanned test image, yielding comparison results that can be used to assess whether print quality of the printing device has degraded below a specified acceptable print quality level (1508).

FIG. 16 shows an example non-transitory computer-readable data storage medium 1600. The computer-readable data storage medium stores program code 1602 executable by a processor, such as that of a computing device or a printing device, to perform processing. The processing includes comparing ROIs of a number of ROI types within a reference image to corresponding ROIs within a scanned test image corresponding to the reference image (1604). The ROIs extracted from the reference image based on an object map distinguishing symbol, raster, and vector objects within the reference image. The processing includes assessing whether print quality of a printing device has degraded below a specified acceptable print quality level, based on results of the comparing (1606).

We claim:

1. A method comprising:
for each region of interest (ROI) type of a plurality of ROI types, extracting ROIs of the ROI type from a reference image based on an object map distinguishing symbol, raster, and vector objects within the reference image; and
assessing whether print quality of a printing device has degraded below a specified acceptable print quality level, based on a comparison of the extracted ROIs within the reference image to corresponding ROIs within a test image corresponding to the reference image and printed by the printing device.

2. The method of claim 1, further comprising:
responsive to assessing that the print quality of the printing device has degraded below the specified acceptable print quality level, performing a correction action at the printing device to improve the degraded print quality.

3. The method of claim 1, wherein the ROI types comprise a raster ROI type, the ROIs of the raster ROI type comprising pixel-based graphics.

4. The method of claim 3, wherein extracting the ROIs of the raster ROI type comprises:
extracting a raster map from the object map;
applying a connected component technique to the extracted raster map under a plurality of constraints to identify connected components within the extracted raster map; and
masking the reference image by the identified connected components,
wherein portions of the reference image masked by the identified connected components constitute the extracted ROIs of the raster ROI type.

5. The method of claim 4, wherein extracting the ROIs of the raster ROI type further comprises:
performing morphological operations on the extracted raster map prior to application of the connected component technique; and
removing the connected components that are smaller than a specified threshold size.

6. The method of claim 1, wherein the ROI types comprise a symbol ROI type, the ROIs of the symbol ROI type comprising symbols and text.

7. The method of claim 6, wherein extracting the ROIs of the symbol ROI type comprises:
extracting a symbol map from the object map;
applying a connected component technique to the extracted symbol map to identify first connected components corresponding to individual characters of symbols and text within the extracted symbol map;
dilating the first connected components to merge the first connected components into a smaller number of second connected components; and
masking the reference image by the second connected components,
wherein portions of the reference image masked by the second connected components constitute the extracted ROIs of the symbol ROI type.

8. The method of claim 7 wherein extracting the ROIs of the symbol ROI type further comprises:
cropping any extracted ROI of the symbol ROI type overlapping any extracted ROI of a raster ROI type comprising pixel-based graphics.

9. The method of claim 1, wherein the ROI types comprise a background ROI type, the ROIs of the background ROI type comprising uniform white color areas.

10. The method of claim 9, wherein extracting the ROIs of the background ROI type comprises:
extracting a background map from the object map;
masking the reference image using the background map; and
repeatingly extracting a given ROI of the background ROI type from the masked reference image and additionally masking the masked reference image to exclude the given ROI, until the given ROI most recently extracted is smaller than a specified threshold size.

11. The method of claim 10, wherein extracting the given ROI of the background ROI type comprises:
extracting a deepest ROI of the background ROI type using a chessboard technique or extracting a maximum ROI of the background ROI type using an accumulation matrix technique.

12. The method of claim 10, wherein extracting the ROIs of the background ROI type further comprises:
masking the reference image to exclude any extracted ROI of a raster ROI type comprising pixel-based graphics and any extracted ROI of a symbol ROI type comprising symbols and text.

13. The method of claim 1, wherein the ROI types comprise a vector ROI type, the ROIs of the vector ROI type comprising uniform non-white and smooth gradient color areas.

14. A printing device comprising:
printing hardware to print a test image corresponding to a reference image from which a plurality of regions of interest (ROIs) of a plurality of ROI types have been extracted based on an object map distinguishing symbol, raster, and vector objects within the reference image;
scanning hardware to scan the printed test image; and
hardware logic to:
compare the ROIs of each ROI type within the reference image to corresponding ROIs within the scanned test image, yielding comparison results used to assess whether print quality of the printing device has degraded below a specified acceptable print quality level.

15. A non-transitory computer-readable data storage medium storing program code executable by a processor to perform processing comprising:
comparing a plurality of regions of interest (ROIs) of a plurality of ROI types within a reference image to corresponding ROIs within a scanned test image correspondence to the reference image, the ROIs extracted from the reference image based on an object map distinguishing symbol, raster, and vector objects within the reference image; and
assessing whether print quality of a printing device has degraded below a specified acceptable print quality level, based on results of the comparing.
